(19) United States
(12) Patent Application Publication
(10) Pub. No.: US 2014/0087053 A1
(43) Pub. Date: Mar. 27, 2014

(54) DRINK

(71) Applicant: Alberto Ferrari, Spilamberto (MO) (IT)

(72) Inventor: Alberto Ferrari, Spilamberto (MO) (IT)

(21) Appl. No.: 14/114,820

(22) PCT Filed: May 2, 2012
(86) PCT No.: PCT/IB2012/000843

§ 371 Date: Oct. 30, 2013

(30) Foreign Application Priority Data
May 3, 2011 (IT) MO2011A000095

(51) Int. Cl. A23L 2/52

(52) U.S. Cl. CPC A23L 2/52
USPC 426/590

(57) ABSTRACT

The drink includes a mix of apple vinegar (1), balsamic vinegar (2) and concentrated grape must (3).

### TECHNICAL FIELD

The present invention relates to a drink.

### BACKGROUND ART

It is known how the need is particularly felt in many industrial and artisan business activity sectors to renew products and to find new ones in order to more strongly distinguish them from those of the competition.

Such need is particularly felt in the “beverage” sector dedicated to the preparation and the distribution of drinks suitable for human consumption.

To cater to the above need, non-alcoholic, cold or hot drinks are known, prepared with a concentrated dose of product (orange juice, lemon juice, etc.) which is diluted with normal water (still drinks) or with water saturated with carbon dioxide (sparkling drinks).

Besides the need to offer drinks of diversified taste with respect to those of the competition, it is underlined that in this sector, the search is increasingly gaining ground for drinks which are highly thirst quenching and which, at the same time, are able to provide the user with a relative well-being, e.g., because they are able to integrate salts or other mineral substances (sport drinks and energy drinks).

Such needs often remain unsatisfied however.

The drinks currently known on the market in fact hardly ever manage to combine the fact of being thirst-quenching drinks with the fact that they provide well-being, and when they do manage to do so they usually have a fairly unpleasant taste and flavour.

Besides this, it must be underlined that most of the drinks currently on the market and which are said to provide beneficial effects for users, are in fact only able to provide the human organism with a quantity of vitamins, salts and other mineral substances which, however beneficial, have no curative or therapeutic type properties.

### DESCRIPTION OF THE INVENTION

The main aim of the present invention is to provide a drink which allows to satisfy the above mentioned needs.

In particular, the purpose of the present invention is to provide a drink which, on the one hand, is thirst-quenching and tasty as regards flavour and, on the other hand, has not only beneficial, but also therapeutic properties for the user.

Another object of the present invention is to provide a drink which allows to overcome the mentioned drawbacks of the state of the art within the ambit of a simple, rational, easy and effective to use as well as low cost solution.

The above objects are achieved by the present drink, characterised by the fact that it comprises a mix of apple vinegar, balsamic vinegar and concentrated grape must.

### BRIEF DESCRIPTION OF THE DRAWINGS

Other characteristics and advantages of the present invention will become more evident from the description of a preferred, but not sole, embodiment of a process for obtaining the drink, illustrated purely as an example but not limited to the annexed drawings in which:

FIG. 1 is a block diagram of the process for obtaining the drink according to the invention.

### EMBODIMENTS OF THE INVENTION

The drink according to the invention comprises a mix of apple vinegar 1, balsamic vinegar 2 and concentrated grape must 3.

Apple vinegar 1 is meant as a product made by refining cider or apple must by means of an acidification process.

The apple vinegar 1 has beneficial and therapeutic properties, including refreshing, antibacterial, antioxidant, hypotensive, hypoglycaemic and anti-cancer properties and preventive action against osteoporosis and anti-inflammatory action on the mouth and throat cavity.

Usefully, the balsamic vinegar 2 is of the PGI balsamic vinegar of Modena type, as defined on the basis of EEC regulation 583/2009 dated 3 Jul. 2009.

The concentrated grape must 3 is meant as liquid sugar obtained from grape must by means of depuration and subsequent concentration.

According to EU regulations, the concentrated grape must is defined as: “non-caramelized liquid product obtained using any partial dehydration means, except direct fire, originating from specific recommended or authorised varieties produced by the Community, totally deprived of its ionic components”.

In particular, in the present invention, the concentrated grape must 3 advantageously has a natural ratio of glucose and fructose substantially equal to 50%, i.e., out of a total of 100 g of sugar, 50 g are glucose and 50 g are fructose. The use of fructose is justified by the fact that this sugar is about 1.5 times sweeter than sucrose and about 3 times sweeter than glucose.

For this reason, its use allows obtaining a product with a lower calorie content. Besides this, the fructose has a pleasant flavour which recalls that of ripe fruit. Usefully, the mix can contemplate the addition of extracts of natural origin 4.

The extracts of natural origin are chosen from the list comprising: blueberry extracts, strawberry extracts, pomegranate extracts, raspberry extracts, cherry extracts, grape extracts, tangerine extracts, lemon extracts, orange extracts, green tea extracts, extracts with high contents of bio-phenols of oenological origin.

The presence of bilberry, strawberry and other extracts permits providing the drink with pleasant and appealing aromas and flavours and, at the same time, enriching it with substances useful for the health inasmuch as, for example, rich in vitamins and antioxidant compounds.

Similar functions are also attributable to the above extracts of oenological origin, e.g., obtained from the skins and pulp of grapes and generally known as phenolic compounds.

The phenolic compounds in fact are highly beneficial to human health because of their antioxidant and free radical scavenging properties, including the protective effects against brain degeneration processes, anti-inflammatory effects, anti-cancer action, anti-atherogenic action and heart protection action.

Phenolic compounds such as catechins, proanthocyanidins, monomer and oligomer flavanes are among the most active substances as regards antioxidant activity.

In particular, grape seed extracts, mainly made up of flavonoids, above all catechin and epicatechin (also present as gallic esters), in the form of monomers, dimers and trimers, have strong antioxidant and free radical scavenging properties.

Besides these substances, widely present in the oenological field, other polyphenols exist which are interesting in terms of their beneficial capacities: quercetin and rutin, which are highly effective in preventing the platelet aggregation and the development of tumor growth, or resveratrol.

Usefully, the mix comprises apple vinegar 1, balsamic vinegar 2, concentrated grape must 3 and extracts of natural origin 4 in the following weight concentrations, meaning with respect to the total weight of the mix:

| | |
|---|---|
| apple vinegar | 30 ÷ 50% |
| balsamic vinegar | 15 ÷ 25% |
| concentrated grape must | 25 ÷ 45% |
| extracts of natural origin | 0 ÷ 10% |

More in detail, the mix comprises apple vinegar 1, balsamic vinegar 2, concentrated grape must 3 and extracts of natural origin 4 in the following weight concentrations:

| | |
|---|---|
| apple vinegar | 40% |
| balsamic vinegar | 20% |
| concentrated grape must | 35% |
| extracts of natural origin | 5% |

The mix thus obtained appears like a dark and dense liquid, dark red in colour, with a pleasant aromatized sweet and sour flavour.

Such mix is ready to be diluted in water, to form a drink having a dilution ratio between 1/3 and 1/7, i.e., wherein, one part of mix is to be found every two or six parts of water respectively.

Preferably, the mix is intended to be diluted in water with a dilution ratio of 1/5, i.e., one part of mix every four parts of water.

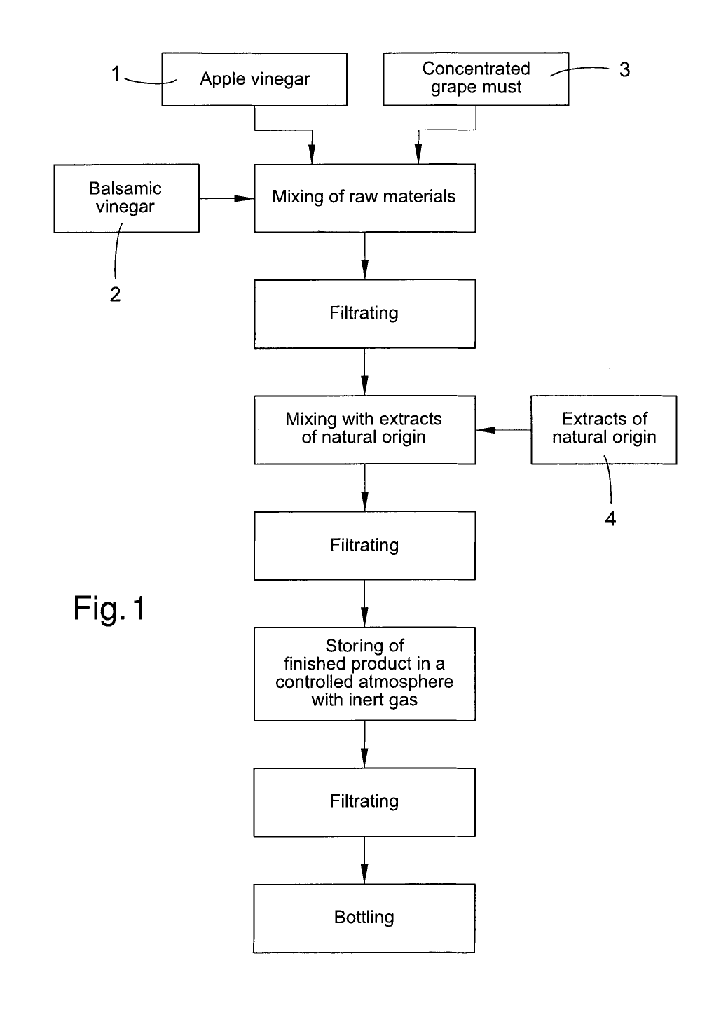

The process for obtaining the mix as it is described is schematically illustrated in FIG. 1 and comprises:
providing the raw materials, i.e. apple vinegar 1, balsamic vinegar 2, grape must 3 and extracts of natural origin 4;
mixing the apple vinegar 1, balsamic vinegar 2 and grape must 3;
filtering the semi-finished product thus obtained;
mixing the filtered semi-finished product with the extracts of natural origin 4;
filtering the mix;
storing the mix in a controlled atmosphere with inert gas;
further filtering the mix; and
bottling the mix.

The drink according to the invention is therefore meant to be introduced onto the market in the form of concentrated mix which the end user dilutes with water before using.

Alternatively, the mix can be diluted with water before bottling, in which case, the drink is placed on the market already suitably dosed and ready for consumption by users.

In this latter case, dilution can occur at the end of the process, immediately before bottling.

Alternatively, dilution occurs during mixing, adding water to the raw materials.

It must be underlined, in any case, that the placing on the market of the drink already diluted preferably requires that the last filtration step immediately before bottling occur in conditions of sterility, to prevent the drink thus bottled from quickly deteriorating or altering its condition, taking into account its water content.

The undiluted mix has a Ph of around 3.

The undiluted mix, furthermore, has a brix degree of around 45° Bx.

The diluted drink, on the other hand, has a Ph of around 3.4.

Finally, the brix degree of the diluted drink is around 14° Bx.

1-10. (canceled)

11. Drink, wherein said drink comprises a mix of apple vinegar (1), balsamic vinegar (2), concentrated grape must (3) and extracts of natural origin (4).

12. Drink according to claim 11, wherein said extracts of natural origin (4) are selected from the list comprising:
blueberry extracts, strawberry extracts, pomegranate extracts, raspberry extracts, cherry extracts, grape extracts, tangerine extracts, lemon extracts, orange extracts, green tea extracts, extracts with high contents of bio-phenols of oenological origin.

13. Drink according to claim 11, wherein said balsamic vinegar (2) is of the PGI balsamic vinegar of Modena type.

14. Drink according to claim 11, wherein said concentrated grape must (3) has a natural ratio of glucose and fructose substantially equal to 50%.

15. Drink according to claim 11, wherein said mix comprises apple vinegar (1), balsamic vinegar (2), concentrated grape must (3) and extracts of natural origin (4) in the following weight concentrations:

| | |
|---|---|
| apple vinegar | 30 ÷ 50% |
| balsamic vinegar | 15 ÷ 25% |
| concentrated grape must | 25 ÷ 45% |
| extracts of natural origin | 0 ÷ 10%. |

16. Drink according to claim 11, wherein said mix comprises apple vinegar (1), balsamic vinegar (2), concentrated grape must (3) and extracts of natural origin (4) in the following weight concentrations:

| | |
|---|---|
| apple vinegar | 40% |
| balsamic vinegar | 20% |
| concentrated grape must | 35% |
| extracts of natural origin | 5%. |

17. Drink according to claim 11, wherein said mix is diluted in water.

18. Drink according to claim 11, wherein said mix is diluted in water with a dilution ratio between 1/3 and 1/7.

19. Drink according to claim 11, wherein said mix is diluted in water with a dilution ratio substantially equal to 1/5.
